(19) United States
(12) Patent Application Publication
(10) Pub. No.: US 2013/0225090 A1
(43) Pub. Date: Aug. 29, 2013

(54) METHOD AND SYSTEM FOR ANTENNA ALIGNMENT

(71) Applicant: Huawei Technologies Co., Ltd., (US)

(72) Inventors: Xiongshu Yi, Chengdu (CN); Song Zhang, Chengdu (CN)

(73) Assignee: Huawei Technologies Co., Ltd., Shenzhen (CN)

(21) Appl. No.: 13/786,248

(22) Filed: Mar. 5, 2013

Related U.S. Application Data
(63) Continuation of application No. PCT/CN2012/082831, filed on Oct. 12, 2012.

(30) Foreign Application Priority Data
Feb. 24, 2012 (CN) 201210043566.3

(51) Int. Cl. H04B 17/00

(52) U.S. Cl. CPC H04B 17/00
USPC 455/63.4

(57) ABSTRACT

The present invention discloses a method and a system for antenna alignment. In the method and the system for antenna alignment in embodiments of the present invention, a strength value of an electromagnetic wave signal is determined in a receiving direction of an antenna to be aligned, and is displayed, so that a user performs an antenna alignment operation according to a display value, thereby improving precision in antenna alignment, and reducing difficulty and a cost in antenna alignment.

### CROSS-REFERENCE TO RELATED APPLICATIONS

This application is a continuation of International Application No. PCT/CN2012/082831, filed on Oct. 12, 2012, which claims priority to Chinese Patent Application No. 201210043566.3, filed on Feb. 24, 2012, both of which are hereby incorporated by reference in their entireties.

### TECHNICAL FIELD

The present invention relates to the field of communications, and in particular, to a method and a system for antenna alignment in the field of communications.

### BACKGROUND

In a communication system including a macro base station (Macro Base Station, “Macro BS” for short), a micro base station (Micro Base Station, “Micro BS” for short)/pico base station (Pico Base Station, “Pico BS” for short), and a user equipment (User Equipment, “UE” for short), the micro base station or the pico base station is abase station for the user equipment to access, and directly serves the user equipment such as a mobile phone, while the macro base station maybe connected to a core network through, for example, a wired or microwave communication link. A problem existing in the communication system is how to transmit service data of a terminal user to the macro base station.

At present, the foregoing problem is usually solved by adopting the following two solutions. One solution is to adopt a wired connection, such as a cable or an optical fiber, but a wiring cost and a labor cost of the solution are both very high. The other solution is to adopt a wireless backhaul technology. The wireless backhaul technology may be a microwave wireless technology, and may also be a low carrier frequency wireless technology based on the wireless fidelity (Wireless Fidelity, “WIFI” for short), 802.16 protocol, or long term evolution (Long Term Evolution, “LTE” for short), and in order to reduce power and reduce network interference, a directional antenna is usually adopted in the wireless backhaul technology.

Because the directional antenna is adopted in the wireless backhaul technology, if a signal transmitting direction is not aligned with a destination antenna, namely, a transmitting antenna is not aligned with an apex having a maximum gain of the destination antenna, signal quality deteriorates or serious power waste is caused. Therefore, how to implement antenna alignment becomes an important problem to be solved in the wireless backhaul solution.

At present, in consideration of safety and radiation, during alignment of an antenna, a power source of a backhaul access point (Backhaul Access Point, “BH AP” for short) is usually not turned on. However, if the power source of the device is not turned on, debugging cannot be performed, so that whether the antenna is aligned cannot be determined. Therefore, during alignment of an antenna, an engineering worker needs to first install the antenna at a high place (generally more than 5 meters high), then go down from the high place, turn on the power source of the device and detect the device on the ground, and reach the high place again to debug the antenna. Moreover, the engineering worker usually needs to go back and forth many times to align the antenna. Therefore, installation and debugging are difficult, alignment precision is low, and a cost is high.

### SUMMARY

Embodiments of the present invention provide a method and a system for antenna alignment, which can improve precision in antenna alignment, and reduce difficulty and a cost in antenna alignment.

In one aspect, an embodiment of the present invention provides a method for antenna alignment, where the method includes: receiving, in a receiving direction of a first antenna, an electromagnetic wave signal transmitted by a second antenna; determining a strength value of the electromagnetic wave signal; converting the strength value into a display value within a predetermined range; and displaying the display value, so that a user determines, according to the display value, whether the first antenna is aligned with the second antenna.

In another aspect, an embodiment of the present invention provides a system for antenna alignment, where the system includes a displaying module and a communication device having a first antenna. The communication device further includes: a receiving unit, configured to receive, in a receiving direction of the first antenna, an electromagnetic wave signal transmitted by a second antenna; a first determining unit, configured to determine a strength value of the electromagnetic wave signal; and a converting unit, configured to convert the strength value into a display value within a predetermined range. The displaying module is configured to display the display value, so that a user determines, according to the display value, whether the first antenna is aligned with the second antenna.

Based on the foregoing technical solutions, in the method and the system for antenna alignment in the embodiments of the present invention, a strength value of an electromagnetic wave signal is determined in a receiving direction of an antenna to be aligned, and is displayed, so that a user performs an antenna alignment operation according to a display value, thereby improving precision in antenna alignment, and reducing difficulty and a cost in antenna alignment.

### BRIEF DESCRIPTION OF DRAWINGS

To illustrate the technical solutions in the embodiments of the present invention more clearly, the following briefly introduces accompanying drawings required for describing the embodiments of the present invention. Apparently, the accompanying drawings in the following description are merely some embodiments of the present invention, and a person of ordinary skill in the art may further obtain other drawings according to the accompanying drawings without creative efforts.

FIG. 1 is a schematic flow chart of a method for antenna alignment according to an embodiment of the present invention;

FIG. 2 is another schematic flow chart of a method for antenna alignment according to an embodiment of the present invention;

FIG. 3 is a schematic block diagram of a system for antenna alignment according to an embodiment of the present invention;

FIG. 4 is another schematic block diagram of a system for antenna alignment according to an embodiment of the present invention;

FIG. 5A and FIG. 5B are still another schematic block diagrams of a system for antenna alignment according to an embodiment of the present invention;

FIG. 6A and FIG. 6B are still another schematic block diagrams of a system for antenna alignment according to an embodiment of the present invention; and

FIG. 7 is still another schematic block diagram of a system for antenna alignment according to an embodiment of the present invention.

### DESCRIPTION OF EMBODIMENTS

The following clearly describes the technical solutions in the embodiments of the present invention with reference to the accompanying drawings in the embodiments of the present invention. Apparently, the embodiments to be described are merely part rather than all of the embodiments of the present invention. All other embodiments obtained by a person of ordinary skill in the art based on the embodiments of the present invention without creative efforts shall fall within the protection scope of the present invention.

It should be understood that, the technical solutions in the embodiments of the present invention may be applied in various communication systems, for example, a global system for mobile communications (Global System for Mobile communications, “GSM” for short) system, a code division multiple access (Code Division Multiple Access, “CDMA” for short) system, a wideband code division multiple access (Wideband Code Division Multiple Access, “WCDMA” for short) system, a general packet radio service (General Packet Radio Service, “GPRS” for short) system, a long term evolution (Long Term Evolution, “LTE” for short) system, an LTE frequency division duplex (Frequency Division Duplex, “FDD” for short) system, an LTE time division duplex (Time Division Duplex, “TDD” for short) system, a universal mobile telecommunication system (Universal Mobile Telecommunication System, “UMTS” for short), a worldwide interoperability for microwave access (Worldwide Interoperability for Microwave Access, “WiMAX” for short) communication system, and a microwave communication system.

In the embodiments of the present invention, a base station may be a base station (Base Transceiver Station, “BTS” for short) in the GSM or CDMA, may also be a base station (NodeB, “NB” for short) in the WCDMA, and may further be an evolutional base station (Evolutional Node B, “ENB or e-NodeB” for short) in the LTE, which is not limited in the present invention.

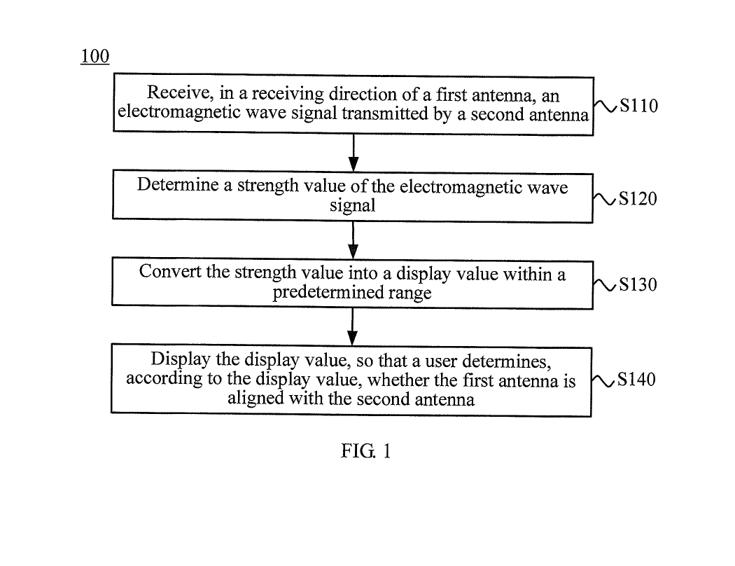

FIG. 1 is a schematic flow chart of a method for antenna alignment 100 according to an embodiment of the present invention. As shown in FIG. 1, the method 100 includes:

S110: Receive, in a receiving direction of a first antenna, an electromagnetic wave signal transmitted by a second antenna.

S120: Determine a strength value of the electromagnetic wave signal.

S130: Convert the strength value into a display value within a predetermined range.

S140: Display the display value, so that a user determines, according to the display value, whether the first antenna is aligned with the second antenna.

In order to perform antenna alignment conveniently, improve precision in antenna alignment, and reduce difficulty and a cost in antenna alignment, a system for antenna alignment may first receive, in a receiving direction of a first antenna to be aligned, an electromagnetic wave signal transmitted by a second antenna, then determine a strength value of the electromagnetic wave signal according to the received electromagnetic wave signal, and convert the determined strength value into a display value within a predetermined range to conform to a use habit of a user, so that the system may display the display value, and the user determines, according to the display value, whether the first antenna is aligned with the second antenna.

Therefore, in the method for antenna alignment in the embodiment of the present invention, a strength value of an electromagnetic wave signal is determined in a receiving direction of an antenna to be aligned, and is displayed, so that a user performs an antenna alignment operation according to a display value, thereby improving precision in antenna alignment, and reducing difficulty and a cost in antenna alignment.

In another aspect, in the method in the embodiment of the present invention, a strength value of a received electromagnetic wave signal is converted into a display value within a predetermined range, so that an ordinary engineering worker can conduct the antenna alignment operation merely according to the display value, and the engineering worker does not need to thoroughly understand physical meaning of strength of an electromagnetic wave signal to determine, according to the strength value of the signal, whether the antenna is aligned, thereby lowering a technical requirement on the engineering worker, and further simplifying the antenna alignment operation and reducing a labor cost in antenna alignment.

In the embodiment of the present invention, the system for antenna alignment that executes the method 100 may be independent of a communication device including a first antenna and have an electromagnetic wave signal receiving function, so that a power source device which has a high power supply voltage and is of the communication device does not need to be turned on when antenna alignment is performed according to the method in the embodiment of the present invention, thereby avoiding exposure of the engineering worker to huge electromagnetic radiation generated by the communication device and a potential electric shock hazard, and improving personal safety of the engineering worker when the antenna alignment operation is implemented.

In another aspect, in the embodiment of the present invention, the system for antenna alignment may receive, by means of an electromagnetic wave signal receiving function of the communication device including the first antenna, an electromagnetic wave signal transmitted by the second antenna and determine signal strength. In this case, to avoid electromagnetic radiation, only a power supply module which has a low power supply voltage and is of the communication device may be enabled in the antenna alignment, and a power supply module which has a high power supply voltage and is of the communication device is enabled after the antenna alignment, so as to receive and transmit a signal.

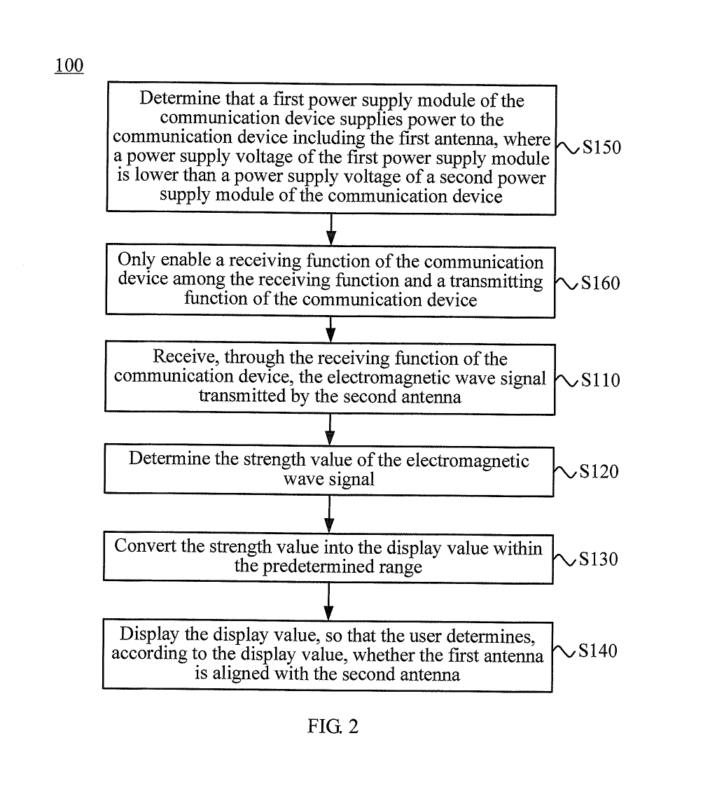

Therefore, as shown in FIG. 2, the method 100 according to the embodiment of the present invention further includes:

S150: Determine that a first power supply module of the communication device supplies power to the communication device including the first antenna, where a power supply voltage of the first power supply module is lower than a power supply voltage of a second power supply module of the communication device.

S160: Only enable a receiving function of the communication device among the receiving function and a transmitting function of the communication device.

The receiving the electromagnetic wave signal transmitted by the second antenna includes: receiving, through the receiving function of the communication device, the electromagnetic wave signal transmitted by the second antenna.

In S150, the system for antenna alignment determines that the first power supply module with the low power supply voltage supplies power to the communication device. The system may determine a power supply status of the communication device in a variety of manners. For example, the system may indicate the power supply status of the communication device through a high level signal and a low level signal. Specifically, for example, the high level signal maybe used to indicate that the first power supply module with the low power supply voltage supplies power to the communication device, and the low level signal may be used to indicate that the second power supply module with the high power supply voltage supplies power to the communication device.

In the embodiment of the present invention, optionally, the first power supply module includes various light or portable power sources temporarily supplying power to the communication device, for example, various power sources such as a mobile battery, an external battery, and a backup battery; and the second power supply module of the communication device includes various domestic power sources or industrial power sources continuously supplying power to the communication device, for example, a domestic power source of 220V or an industrial power source of 380V, which are merely taken as an example for description in the embodiment of the present invention, and to which the embodiment of the present invention is not limited. Compared with the domestic power sources or industrial power sources, the light or portable power sources have a much lower power supply voltage (for example, 3.7V or 5V), which can avoid exposure of the engineering worker to huge electromagnetic radiation generated by the communication device and a potential electric shock hazard, thereby improving personal safety of the engineering worker when the antenna alignment operation is implemented.

It should be understood that, for conciseness and ease of understanding, the first antenna included in the communication device in the embodiment of the present invention is described by using a directional antenna as an example, and the communication device is described by using a backhaul access point BH AP as an example, to which the embodiment of the present invention is not limited. The first antenna may also be an omnidirectional antenna, and the communication device may also be a macro base station, a micro base station, a pico base station, a backhaul base station (Backhaul Base Station, “BH BS” for short), a backhaul access point BH AP, or various microwave devices.

In S160, the system for antenna alignment only enables the receiving function of the communication device and does not enable the transmitting function of the communication device among the receiving function and the transmitting function of the communication device, thereby further reducing the electromagnetic radiation generated by the communication device, and improving the safety in antenna alignment.

In S110, the system for antenna alignment receives, through the receiving function of the communication device, the electromagnetic wave signal transmitted by the second antenna. For example, when the system for antenna alignment determines, according to the high level signal, that a battery supplies power to the communication device BH AP, the system for antenna alignment only enables cell signal strength measurement and does not enable the transmitting function of the BH AP, and controls that the first antenna receives the electromagnetic wave signal transmitted by the second antenna.

In S120, the system for antenna alignment determines the strength value of the electromagnetic wave signal.

In the embodiment of the present invention, the system may determine the strength value of the received electromagnetic wave signal in a variety of manners. For example, the system may obtain a power value of the received electromagnetic wave signal by collecting statistics about time domain signals; the system may also complete an access procedure based on an existing protocol procedure, such as the LTE, WIFI, and worldwide interoperability for microwave access (Worldwide Interoperability for Microwave Access, “WiMAX” for short), perform reference signal receiving power (Reference Signal Receiving Power, “RSRP” for short) or received signal strength indication (Received Signal Strength Indication, “RSSI” for short) measurement, and determine the strength value of the received electromagnetic wave signal.

It should be understood that, performing RSRP or RSSI measurement in an LTE system is merely taken as an example for description in the embodiment of the present invention, and the strength value of the electromagnetic wave signal may be determined according to other existing protocols in other communication systems.

In the embodiment of the present invention, optionally, the system for antenna alignment determines, according to the following equations (1) to (4), the strength value P_{dBm} which is expressed in dBm and is of the electromagnetic wave signal:

$$\begin{matrix}P ( j ) = \frac{1}{M} {\sum }_{i = 0}^{M - 1} {‖ r ( i ) ‖}_{F}^{2} & ( 1 ) \\ \tilde{P} ( 0 ) = P ( 0 ) & ( 2 ) \\ \tilde{P} ( j ) = α \cdot P ( j ) + ( 1 - α ) \cdot \tilde{P} ( j - 1 ) & ( 3 ) \\ {P}_{dBm} ( j ) = 10 \cdot 1 g ( \tilde{P} ( j ) ) + A & ( 4 )\end{matrix}$$

where P(j) is an instantaneous power value in a j^{th} measurement; j is a non-negative integer; M is the number of time domain sampling points in a window length in a single measurement; r(i) is the received electromagnetic wave signal; \tilde{P}(j) is a power value which has undergone filter processing and is in the j^{th} measurement; α is a filter processing coefficient; and A is a constant.

In equations (2) and (3), to reduce an effect caused by signal fluctuation, filter processing may be performed on the instantaneous power value P(j) in the j^{th} measurement by using an alpha filter, to obtain the power value \tilde{P}(j) which has undergone filter processing and is in the j^{th} measurement. In the equation (4), 10·1g(\tilde{P}(j)) is a digital domain strength value expressed in dBm, and the digital domain strength value needs to correspond to analog power at an input port of an antenna. Therefore, an analog strength value in the j^{th} measurement is obtained after \tilde{P}(j) has undergone the processing in equation (4), where the constant A is related to radio-frequency and intermediate-frequency digital processing.

It should be understood that, in the embodiment of the present invention, the effect of signal fluctuation may be reduced through other filter processing, to which the embodiment of the present invention is not limited.

In S130, the system for antenna alignment converts the strength value into the display value within the predetermined range.

In the embodiment of the present invention, optionally, the system converts the strength value into the display value E determined according to the following equation (5):

$$E = [ ( {P}_{dBm} + B ) \cdot \frac{{10}^{n} - 1}{Y - X} ] \qquad ( 5 )$$

where B is a constant; n is the number of digits of the display value; X is a minimum strength value which is expressed in dBm and is of the electromagnetic wave signal; Y is a maximum strength value which is expressed in dBm and is of the electromagnetic wave signal; and [ ] is an operation symbol for rounding.

For example, assuming that a range of the strength value which is expressed in dBm and is of the electromagnetic wave signal is (X,Y), and the number of digits of the display value finally presented to the user is n=2, namely, the strength value is converted to a predetermined range from 0 to 99, the display value E may be determined according to the following equation (6):

$$E = [ ( {P}_{dBm} + B ) \cdot \frac{99}{Y - X} ] \qquad ( 6 )$$

where B is a constant, for example, B=|X|, so as to convert the strength value P_{dBm} that is determined through the foregoing equations (1) to (4) and is usually negative into a positive value, and in order to conform to a use habit of the user, the strength value of the electromagnetic wave signal is converted into a display value only indicating the signal strength, thereby lowering the technical requirement on the engineering worker, and further simplifying the antenna alignment operation and reducing the labor cost in antenna alignment.

It should be understood that, in the embodiment of the present invention, the strength value of the signal may also be converted through other processing; the operation symbol [ ] for rounding includes around up operation and also includes a round down operation; and the number of digits n of the display value may also be other natural numbers such as 1, 2, and 3, to which the embodiment of the present invention is not limited.

In S140, the system for antenna alignment displays the display value, so that the user determines, according to the display value, whether the first antenna is aligned with the second antenna. For example, the user may find, according to the display value, a location where the received signal is strongest, and fixedly install the first antenna, thereby implementing alignment of the first antenna with the second antenna.

It should be understood that, in the embodiments of the present invention, the serial numbers of the foregoing steps do not imply an execution sequence, and the execution sequence of the steps should be determined according to functions and internal logic, so the serial numbers are not intended to limit the implementation process of the embodiments of the present invention.

In addition, the term “and/or” in this document is only an association relationship for describing associated objects, and indicates that three relationships may exist, for example, A and/or B may indicate the following three cases: A exists separately, both A and B exist, and B exists separately. In addition, the character “/” in this document usually indicates that the former and later associated objects are in a “or” relationship.

Therefore, in the method for antenna alignment in the embodiment of the present invention, a strength value of an electromagnetic wave signal is determined in a receiving direction of an antenna to be aligned, and is displayed, so that a user performs an antenna alignment operation according to a display value, thereby improving precision in antenna alignment, and reducing difficulty and a cost in antenna alignment.

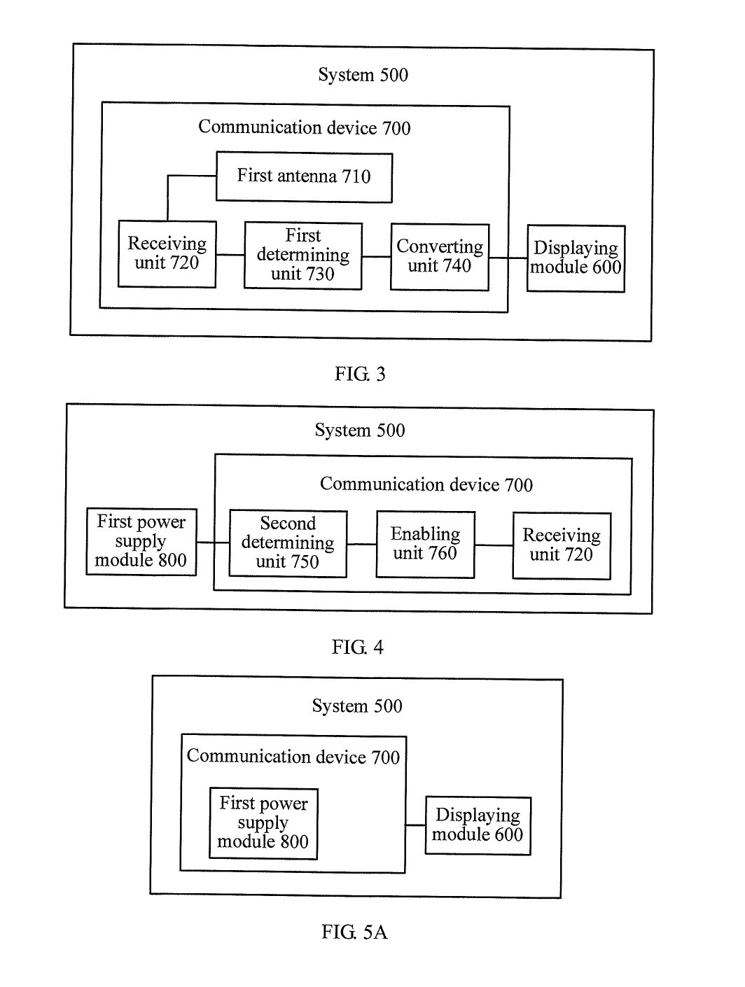

The method for antenna alignment according to the embodiment of the present invention is described in detail in the foregoing with reference to FIG. 1 and FIG. 2, and a system for antenna alignment according to an embodiment of the present invention is described in detail in the following with reference to FIG. 3 to FIG. 7.

FIG. 3 is a schematic block diagram of a system for antenna alignment 500 according to an embodiment of the present invention. As shown in FIG. 3, the system 500 includes a displaying module 600 and a communication device 700 having a first antenna 710. The communication device 700 further includes:

a receiving unit 720, configured to receive, in a receiving direction of the first antenna 710, an electromagnetic wave signal transmitted by a second antenna;

a first determining unit 730, configured to determine a strength value of the electromagnetic wave signal; and

a converting unit 740, configured to convert the strength value into a display value within a predetermined range;

The displaying module 600 is configured to display the display value, so that a user determines, according to the display value, whether the first antenna is aligned with the second antenna.

Therefore, in the system for antenna alignment in the embodiment of the present invention, a strength value of an electromagnetic wave signal is determined in a receiving direction of an antenna to be aligned, and is displayed, so that a user performs an antenna alignment operation according to a display value, thereby improving precision in antenna alignment, and reducing difficulty and a cost in antenna alignment.

In the embodiment of the present invention, optionally, as shown in FIG. 4, the system 500 further includes:

a first power supply module 800, configured to supply power to the communication device 700, where a power supply voltage of the first power supply module 800 is lower than a power supply voltage of a second power supply module of the communication device 700.

The communication device 700 further includes:

a second determining unit 750, configured to determine that the first power supply module 800 supplies power to the communication device 700; and

an enabling unit 760, configured to only enable a receiving function among the receiving function and a transmitting function of the communication device 700.

The receiving unit 720 is further configured to receive, through the receiving function of the communication device 700, the electromagnetic wave signal transmitted by the second antenna.

In the embodiment of the present invention, the first power supply module includes various low voltage power sources temporarily supplying power to the communication device; and the second power supply module includes various power sources continuously supplying power to the communication device. Optionally, the first power supply module includes various light or portable power sources, for example, various power sources such as a mobile battery, an external battery, and a backup battery. Optionally, the second power supply module includes various domestic power sources or industrial power sources, for example, a domestic power source of 220V or an industrial power source of 380V.

In the embodiment of the present invention, optionally, the first determining unit 730 is further configured to determine, according to the following equations, the strength value P_{dBm} which is expressed in dBm and is of the electromagnetic wave signal:

$$\begin{matrix}P ( j ) = \frac{1}{M} {\sum }_{i = 0}^{M - 1} {‖ r ( i ) ‖}_{F}^{2} ; \\ \tilde{P} ( 0 ) = P ( 0 ) ; \\ \tilde{P} ( j ) = α \cdot P ( j ) + ( 1 - α ) \cdot \tilde{P} ( j - 1 ) ; \\ {P}_{dBm} ( j ) = 10 \cdot 1 g ( \tilde{P} ( j ) ) + A ;\end{matrix}$$

where P(j) is an instantaneous power value in a j^{th} measurement; j is a non-negative integer; M is the number of time domain sampling points in a window length in a single measurement; r(i) is the received) electromagnetic wave signal; \tilde{P}(j) is a power value which has undergone filter processing and is in the j^{th} measurement; α is a filter processing coefficient; and A is a constant.

In the embodiment of the present invention, optionally, the converting unit 740 is further configured to convert the strength value into the display value E determined according to the following equation:

$$E = [ ( {P}_{dBm} + B ) \cdot \frac{{10}^{n} - 1}{Y - X} ] ;$$

where B is a constant; n is the number of digits of the display value; X is a minimum strength value which is expressed in dBm and is of the electromagnetic wave signal; Y is a maximum strength value which is expressed in dBm and is of the electromagnetic wave signal; and [ ] is an operation symbol for rounding. For example, B=|X|.

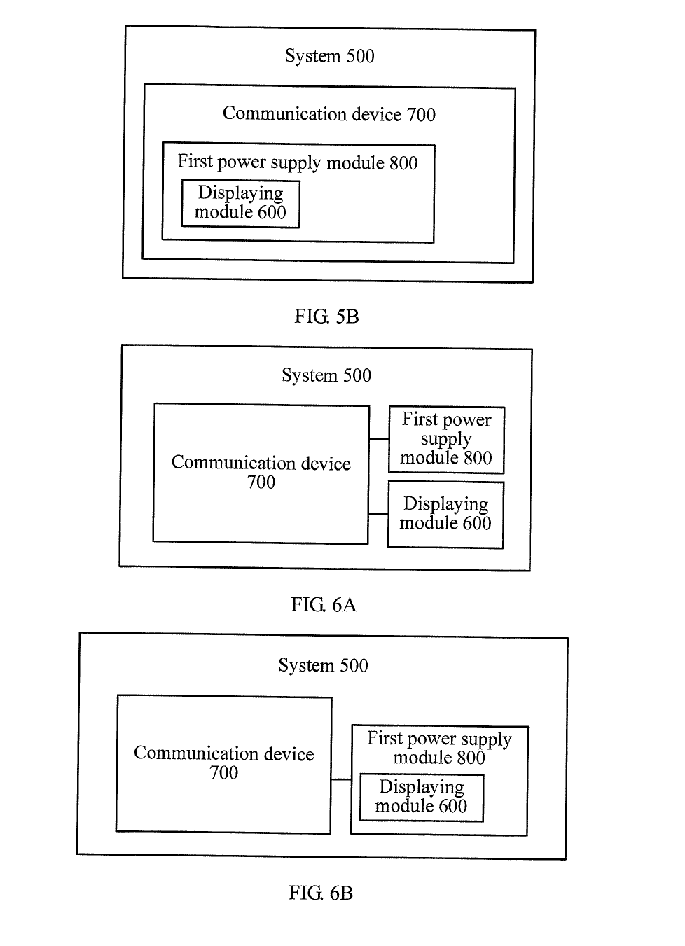

In the embodiment of the present invention, as shown in FIG. 5A or FIG. 5B, optionally, the first power supply module 800 is integrated in the communication device 700. For example, two power supply modules are disposed inside the communication device 700, one power supply module is a working power source for the communication device to receive and/or transmit a signal, and the other power supply module is a power source with a low power supply voltage for antenna alignment, for example, a battery. It should be understood that, when the first power supply module is a battery, a battery insertion opening included in the communication device should be easy to be opened and closed for battery insertion.

In the embodiment of the present invention, as shown in FIG. 6A or FIG. 6B, optionally, the first power supply module 800 is disposed separately, and supplies power to the communication device 700 through a power source interface on the communication device 700. That is, the first power supply module is disposed separately from the communication device, and may supply power to the communication device 700 through a power source interface, such as a universal serial bus (Universal Serial BUS, “USB” for short) and a power over Ethernet (Power Over Ethernet, “POE” for short).

In the embodiment of the present invention, as shown in FIG. 5A or FIG. 6A, optionally, the displaying module 600 is disposed on an external surface of the communication device 700. For example, the displaying module 600 is disposed on an external board of the communication device BH AP.

In the embodiment of the present invention, as shown in FIG. 5B or FIG. 6B, optionally, the displaying module 600 is disposed inside a casing of the first power supply module 800, so as to present the displaying module when the casing is opened. In this way, the structure is simple and compact, and easy to be used.

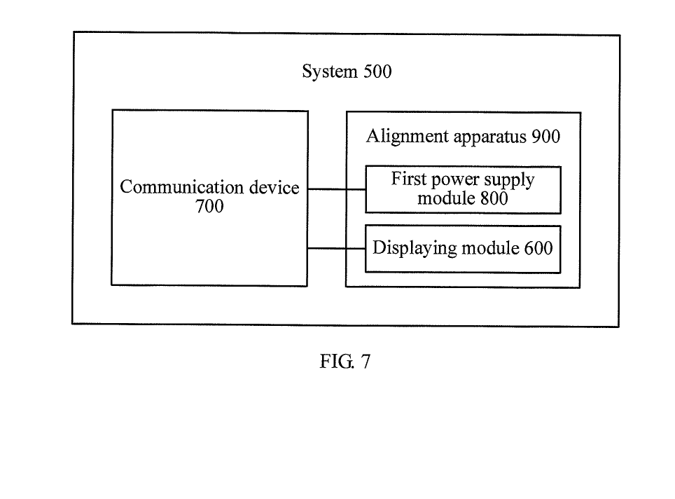

In the embodiment of the present invention, as shown in FIG. 7, optionally, the first power supply module 800 and the displaying module 600 form an alignment apparatus 900 independent of the communication device 700, the first power supply module 800 supplies power to the communication device 700 through a universal serial bus USB interface on the communication device 700, and the displaying module 600 obtains, through the USE interface, the display value transmitted by the communication device 700, and displays the display value.

It should be understood that, the first power supply module may also supply power to the communication device through other interfaces, and the displaying module may also obtain, through other interfaces, the display value transmitted by the communication device, and display the display value, to which the embodiment of the present invention is not limited.

In the embodiment of the present invention, optionally, the alignment apparatus 900 is made of a magnetic material; or the alignment apparatus 900 further includes an adsorption structure, so as to be adsorbed on the external surface of the communication device 700. For example, the alignment apparatus is made of a magnetic material, and may be adsorbed on a metal casing of the communication device BH AP, so that the alignment apparatus can be easily fixed in the antenna alignment, thereby facilitating the antenna alignment operation. For another example, the alignment apparatus may include an apparatus or a structure such as a magnet apparatus and a sucker, so as to be adsorbed on the external surface of the communication device, thereby fixing the alignment apparatus, and facilitating the antenna alignment operation.

It should be understood that, the system for antenna alignment 500 according to the embodiment of the present invention may correspond to an execution subject of the method for antenna alignment according to the embodiment of the present invention, and the foregoing and other operations and/or functions of the modules of the system 500 are for implementing the corresponding procedures of the methods in FIG. 1 and FIG. 2, and for conciseness, details are not repeatedly described here.

Therefore, in the system for antenna alignment in the embodiment of the present invention, a strength value of an electromagnetic wave signal is determined in a receiving direction of an antenna to be aligned, and is displayed, so that a user performs an antenna alignment operation according to a display value, thereby improving precision in antenna alignment, and reducing difficulty and a cost in antenna alignment.

A person of ordinary skill in the art may appreciate that, units and algorithm steps of examples described in combination with the embodiments disclosed in this specification may be implemented by electronic hardware, computer software, or a combination of the two. In order to clearly describe interchangeability between the hardware and the software, compositions and steps of the examples are generally described according to functions in the foregoing description. Whether the functions are executed by hardware or software depends on particular applications and design constraint conditions of the technical solutions. A person skilled in the art may use different methods to implement the described functions for each particular application, but it should not be considered that the implementation goes beyond the scope of the present invention.

It can be clearly understood by a person skilled in the art that, for the purpose of convenient and brief description, for a detailed working process of the foregoing system, apparatus and unit, reference may be made to the corresponding process in the method embodiments, and details are not repeatedly described here.

In the several embodiments provided in the present application, it should be understood that the disclosed system, apparatus, and method may be implemented in other manners. For example, the described apparatus embodiment is merely exemplary. For example, the dividing of the units is merely a kind of logical function dividing, and there may be other dividing manners in actual implementation. For example, multiple units or components may be combined or integrated into another system, or some features may be ignored or not performed. In addition, the shown or discussed mutual couplings or direct couplings or communication connections may be implemented through some interfaces. The indirect couplings or communication connections between the apparatuses or units may be electronic, mechanical, or in other forms.

The units described as separate parts may or may not be physically separate, and parts shown as units may or may not be physical units, may be located in one position, or may be distributed on multiple network units. Part or all of the units here maybe selected according to actual needs to achieve the objectives of the solutions of the embodiments of the present invention.

In addition, functional units in the embodiments of the present invention may be integrated into a processing unit, and each of the units may also exist alone physically, and two or more than two units may also be integrated into one unit. The integrated unit may be implemented in a form of hardware, and may also be implemented in a form of a software functional unit.

When the integrated unit is implemented in the form of a software functional unit and sold or used as an independent product, the integrated unit may be stored in a computer readable storage medium. Based on such understanding, the technical solutions of the present invention essentially, or the part contributing to the prior art, or all or part of the technical solutions may be implemented in the form of a software product. The computer software product is stored in a storage medium and includes several instructions for instructing a computer device (which may be a personal computer, a server, a network device, and the like) to execute all or part of steps of the method described in the embodiments of the present invention. The storage medium includes: any medium that is capable of storing program codes, such as a U disk, a removable hard disk, a read-only memory (ROM, Read-Only Memory), a random access memory (RAM, Random Access Memory), a magnetic disk, or an optical disk.

The foregoing description is merely specific embodiments of the present invention, but is not intended to limit the protection scope of the present invention. A person skilled in the art may easily derive various equivalent modifications or replacements within the technical scope disclosed in the present invention, and these modifications or replacements shall fall within the protection scope of the present invention. Therefore, the protection scope of the present invention shall be subject to the protection scope of the appended claims.

What is claimed is:

1. A method for antenna alignment, the method comprising:
receiving, in a receiving direction of a first antenna, an electromagnetic wave signal transmitted by a second antenna;
determining a strength value of the electromagnetic wave signal;
converting the strength value into a display value within a predetermined range; and
displaying the display value, so that a user determines, according to the display value, whether the first antenna is aligned with the second antenna.

2. The method according to claim 1, wherein the method further comprises:
determining that a first power supply module of a communication device supplies power to the communication device comprising the first antenna, wherein a power supply voltage of the first power supply module is lower than a power supply voltage of a second power supply module of the communication device; and
only enabling a receiving function of the communication device among the receiving function and a transmitting function of the communication device, and
the receiving the electromagnetic wave signal transmitted by the second antenna comprises:
receiving, through the receiving function of the communication device, the electromagnetic wave signal transmitted by the second antenna.

3. The method according to claim 1, wherein the determining the strength value of the electromagnetic wave signal comprises:
determining, according to the following equations, a strength value P_{dBm} which is expressed in dBm and is of the electromagnetic wave signal:
$$\begin{matrix}P ( j ) = \frac{1}{M} {\sum }_{i = 0}^{M - 1} {‖ r ( i ) ‖}_{F}^{2} ; \\ \tilde{P} ( 0 ) = P ( 0 ) ; \\ \tilde{P} ( j ) = α \cdot P ( j ) + ( 1 - α ) \cdot \tilde{P} ( j - 1 ) ; \\ {P}_{dBm} ( j ) = 10 \cdot 1 g ( \tilde{P} ( j ) ) + A ;\end{matrix}$$
wherein P(j) is an instantaneous power value in a j^{th} measurement; j is a non-negative integer; M is the number of time domain sampling points in a window length in a single measurement; r(i) is the received electromagnetic wave signal; \tilde{P}(j) is a power value which has undergone filter processing and is in the j^{th} measurement; α is a filter processing coefficient; and A is a constant.

4. The method according to claim 1, wherein the converting the strength value into the display value within the predetermined range comprises:
converting the strength value into the display value E determined according to the following equation:
$$E = [ ( {P}_{dBm} + B ) \cdot \frac{{10}^{n} - 1}{Y - X} ] ;$$
wherein B is a constant; n is the number of digits of the display value; X is a minimum strength value which is expressed in dBm and is of the electromagnetic wave signal; Y is a maximum strength value which is expressed in dBm and is of the electromagnetic wave signal; and [ ] is an operation symbol for rounding.

5. A system for antenna alignment, the system comprising a displaying module and a communication device having a first antenna, wherein the communication device further comprises:
a receiving unit, configured to receive, in a receiving direction of the first antenna, an electromagnetic wave signal transmitted by a second antenna;
a first determining unit, configured to determine a strength value of the electromagnetic wave signal; and
a converting unit, configured to convert the strength value into a display value within a predetermined range, and wherein
the displaying module is configured to display the display value, so that a user determines, according to the display value, whether the first antenna is aligned with the second antenna.

6. The system according to claim 5, wherein the system further comprises:
a first power supply module, configured to supply power to the communication device, wherein a power supply voltage of the first power supply module is lower than a power supply voltage of a second power supply module of the communication device,
the communication device further comprises:
a second determining unit, configured to determine that the first power supply module supplies power to the communication device; and
an enabling unit, configured to only enable a receiving function among the receiving function and a transmitting function of the communication device, and
the receiving unit is further configured to receive, through the receiving function of the communication device, the electromagnetic wave signal transmitted by the second antenna.

7. The system according to claim 5, wherein the first determining unit is further configured to:
determine, according to the following equations, a strength value P_{dBm} which is expressed in dBm and is of the electromagnetic wave signal:
$$\begin{matrix}P ( j ) = \frac{1}{M} {\sum }_{i = 0}^{M - 1} {‖ r ( i ) ‖}_{F}^{2} ; \\ \tilde{P} ( 0 ) = P ( 0 ) ; \\ \tilde{P} ( j ) = α \cdot P ( j ) + ( 1 - α ) \cdot \tilde{P} ( j - 1 ) ; \\ {P}_{dBm} ( j ) = 10 \cdot 1 g ( \tilde{P} ( j ) ) + A ;\end{matrix}$$
wherein P(j) is an instantaneous power value in a j^{th} measurement; j is a non-negative integer; M is the number of time domain sampling points in a window length in a single measurement; r(i) is the received) electromagnetic wave signal; \tilde{P}(j) is a power value which has undergone filter processing and is in the j^{th} measurement; α is a filter processing coefficient; and A is a constant.

8. The system according to claim 5, wherein the converting unit is further configured to convert the strength value into the display value E determined according to the following equation:
$$E = [ ( {P}_{dBm} + B ) \cdot \frac{{10}^{n} - 1}{Y - X} ] ;$$
wherein B is a constant; n is the number of digits of the display value; X is a minimum strength value which is expressed in dBm and is of the electromagnetic wave signal; Y is a maximum strength value which is expressed in dBm and is of the electromagnetic wave signal; and [ ] is an operation symbol for rounding.

9. The system according to claim 6, wherein
the first power supply module is integrated in the communication device; or
the first power supply module is disposed separately, and supplies power to the communication device through a power source interface on the communication device.

10. The system according to claim 9, wherein
the displaying module is disposed on an external surface of the communication device; or
the displaying module is disposed inside a casing of the first power supply module, so as to present the displaying module when the casing is opened.

11. The system according to claim 6, wherein the first power supply module and the displaying module form an alignment apparatus independent of the communication device, the first power supply module supplies power to the communication device through a universal serial bus USB interface on the communication device, and the displaying module obtains, through the USB interface, the display value transmitted by the communication device, and displays the display value.

12. The system according to claim 11, wherein the alignment apparatus is made of a magnetic material; or the alignment apparatus further comprises an adsorption structure, so as to be adsorbed on the external surface of the communication device.
